(19) United States
(12) Patent Application Publication
(10) Pub. No.: US 2006/0289461 A1
(43) Pub. Date: Dec. 28, 2006

(54) Overheat-sensing circuit and semiconductor integrated circuit device having the same

(75) Inventors: Akio Kojima, Anjo-city (JP); Hiroyuki Ban, Hazu-gun (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/453,028

(22) Filed: Jun. 15, 2006

(30) Foreign Application Priority Data
Jun. 16, 2005 (JP) JP 2005-176419

(51) Int. Cl. H05B 1/02

(52) U.S. Cl. 219/497

(57) ABSTRACT

An overheat-sensing circuit includes a temperature-sensing circuit for outputting a temperature-sensing voltage, a reference voltage generation circuit for outputting a reference voltage, and a comparison circuit that compares the temperature-sensing voltage with the reference voltage and outputs an overheat-sensing signal based on a result of the comparison. The reference voltage generation circuit outputs the reference voltage in accordance with a power supply voltage when the power supply voltage is within a predetermined voltage range. In contrast, the reference voltage generation circuit generates a limited voltage based on the power supply voltage and outputs the reference voltage in accordance with the limited voltage when the power supply voltage is outside the predetermined voltage range. This approach reduces a variation in an overheat-sensing temperature at which the comparison circuit outputs the overheat-sensing signal.

### CROSS REFERENCE TO RELATED APPLICATION

This application is based on and incorporates herein by reference Japanese Patent Application No. 2005-176419 filed on Jun. 16, 2005.

### FIELD OF THE INVENTION

The present invention relates to an overheat-sensing circuit and a semiconductor integrated circuit device having the same.

### BACKGROUND OF THE INVENTION

Recently, there has been an increase in demand for a power integrated circuit (IC). An overheat-sensing circuit is used as a means for preventing short circuit of a transistor used in an output stage of the IC.

An overheat-sensing circuit disclosed in JP-A-2003-294542 uses a temperature characteristic of a diode to detect overheating of the transistor. A generalized circuit of the overheat-sensing circuit is shown in FIG. 5. The overheat-sensing circuit includes a voltage divider circuit 3, a temperature-sensing circuit 4, and a comparator 5.

The voltage divider circuit 3 has resistors R1, R2 connected in series between a power line 1 and a ground line 2, and outputs a reference voltage VR that depends on a power supply voltage VPS applied between the lines 1, 2. The temperature-sensing circuit 4 outputs a temperature-sensing voltage VF that decreases with an increase in temperature. The comparator 5 compares the reference voltage VR with the temperature-sensing voltage VF and outputs an overheat-sensing signal SOV based on a result of the comparison. When the overheat-sensing signal SOV changes to a low level, the transistor is turned off so that the short circuit of the transistor can be prevented. Thus, an overheat-sensing temperature depends on the reference voltage VR. The overheat-sensing temperature is a temperature at which the overheat-sensing circuit changes to an overheat-detected state where the transistor is turned off.

In a burn-in process performed in a screening test, the IC is subjected to thermal stress and a higher voltage than that in a normal operation. In the overheat-sensing circuit shown in FIG. 5, the reference voltage VR increases with an increase in the power supply voltage VPS. Accordingly, the overheat-sensing temperature decreases and the overheat-sensing signal SOV changes to the low level at a temperature lower than the overheat-sensing temperature in the normal operation. Therefore, before or during the burn-in process, the overheat-sensing circuit changes to the overheat-detected state and the transistor used in the output stage of the IC is turned off. Consequently, the screening test may not fully screen out detective products.

By adding an accurate reference voltage generation circuit such as a band-gap reference circuit to the IC, it may be possible to overcome the above program. However, the addition of such a reference voltage generation circuit may increase size, design cost, and manufacturing cost of the IC.

### SUMMARY OF THE INVENTION

In view of the above-described problem, it is an object of the present invention to provide an overheat-sensing circuit in which a variation in an overheat-sensing temperature can be reduced, and a semiconductor integrated circuit device having the overheat-sensing circuit.

An overheat-sensing circuit includes a temperature-sensing circuit for outputting a temperature-sensing voltage that depends on temperature, a reference voltage generation circuit for outputting a reference voltage, and a comparison circuit that compares the temperature-sensing voltage with the reference voltage and outputs an overheat-sensing signal based on a result of the comparison.

The reference voltage generation circuit outputs the reference voltage in accordance with a power supply voltage supplied from an external voltage source when the power supply voltage is within a predetermined voltage range. In contrast, the reference voltage generation circuit generates a limited voltage based on the power supply voltage and outputs the reference voltage in accordance with the limited voltage when the power supply voltage is outside the predetermined voltage range. This approach reduces a variation in an overheat-sensing temperature at which the comparison circuit outputs the overheat-sensing signal.

### BRIEF DESCRIPTION OF THE DRAWINGS

The above and other objectives, features and advantages of the present invention will become more apparent from the following detailed description made with reference to the accompanying drawings. In the drawings:

FIG. 1 is a circuit diagram of an overheat-sensing circuit according to a first embodiment of the present invention;

FIG. 2 is a graph showing a reference voltage and a forward-bias voltage of a diode in a burn-in process and a reference voltage in a normal operation of the overheat-sensing circuit of FIG. 1;

FIG. 3A is a graph showing an overheat-sensing signal of the overheat-sensing circuit of FIG. 1, and FIG. 3B is a graph showing an overheat-sensing signal of an overheat-sensing circuit of FIG. 5;

FIG. 4 is a circuit diagram of an overheat-sensing circuit according to a second embodiment of the present invention; and

FIG. 5 is a circuit diagram of the overheat-sensing circuit according to a prior art.

### DETAILED DESCRIPTION OF THE PREFERRED EMBODIMENTS

(First Embodiment)

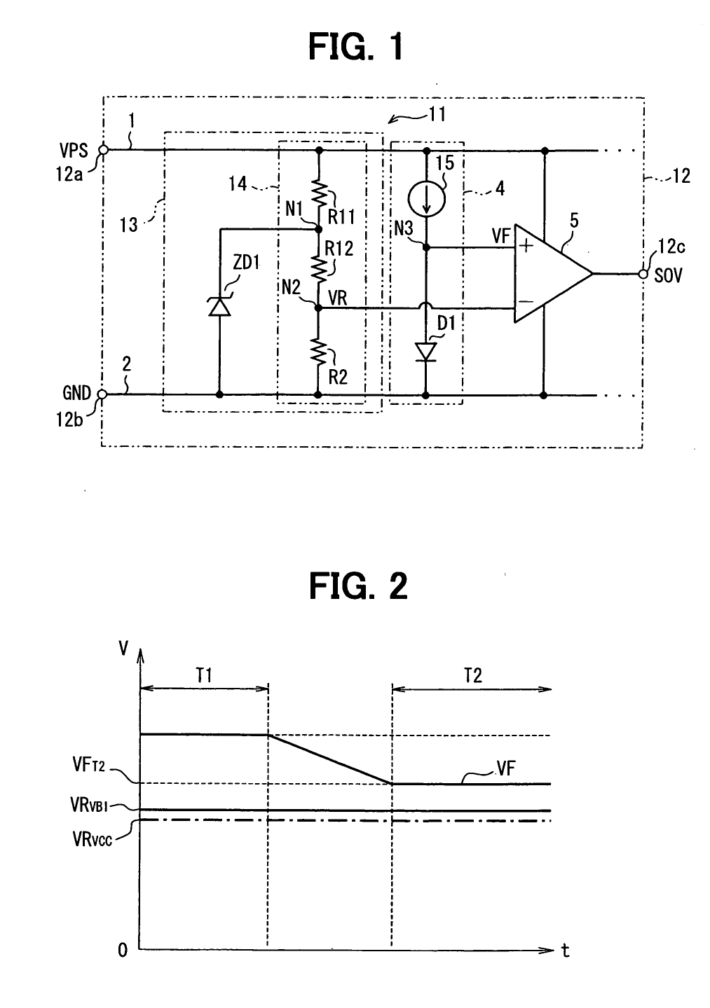

An overheat-sensing circuit 11 according to a first embodiment of the present invention will now be described with reference to FIG. 1. integrated circuit (IC) 12 for driving a solenoid or a motor mounted on a vehicle. The overheat-sensing circuit 11 is thermally coupled to a transistor (not shown) used in output stage of the IC 12 and has a function of detecting an overheat condition caused by an excessive current flowing through the transistor.

The IC 12 has a power supply terminal 12a and a ground terminal 12b through which a power supply voltage VPS is supplied from an external power source (not shown). In a normal operation, the IC 12 is supplied with a normal operating voltage VCC as the power supply voltage VPS. The voltage VCC is highly accurate and may be, for example, 5 volts. In burn-in process performed prior to shipment, the IC 12 is supplied with a burn-in voltage VBI as the power supply voltage VPS. The voltage VBI is higher than the voltage VCC and may be, for example, 8 volts. The power supply terminal 12a and the ground terminal 12b are connected to a power line 1 and a ground line 2 of the IC 12, respectively.

The overheat-sensing circuit 11 includes a temperature-sensing circuit 4, a comparator 5, and a reference voltage generation circuit 13.

The reference voltage generation circuit 13 includes a voltage divider circuit 14 and a zener diode ZD1. The voltage divider circuit 14 has resistors R11, R12, and R2 that are connected in series between the power line 1 and the ground line 2. Specifically, the resistor R11 is connected between the power line 1 and a node N1 at which the resistor R11 and the resistor R12 are connected in series, and the resistor R2 is connected between the ground line 2 and a node N2 at which the resistor R2 and the resistor R12 are connected in series. The zener diode ZD1 has an anode connected to the ground line 2 and a cathode connected to the node N1. In the reference voltage generation circuit 13, a reference voltage VR appears at the node N2.

The temperature-sensing circuit 4 includes a constant current circuit 15 and a diode D1 that are connected in series between the power line 1 and the ground line 2. Specifically, the constant current circuit 15 is connected between the power line 1 and a node N3 at which the constant current circuit 15 is connected to an anode of the diode D1. A cathode of the diode D1 is connected to the ground line 2. In the temperature-sensing circuit 4, a forward-bias voltage VF (i.e., temperature-sensing voltage) of the diode D1 appears at the node N3.

The comparator 5 is powered by the power supply voltage VPS that is applied between the power line 1 and the ground line 2. The comparator 5 has an inverting input terminal connected to the node N2 of the reference voltage generation circuit 13 and a non-inverting terminal connected to the node N3 of the temperature-sensing circuit 4. The comparator 5 compares the reference voltage VR appearing at the node N2 with the forward-bias voltage VF appearing at the node N3 and outputs an overheat-sensing signal SOV based on a result of the comparison. An output terminal of the comparator 5 is connected to both a terminal 12c of the IC 12 and a current interruption circuit (not shown) for interrupting a current flowing through the transistor used in the output stage of the IC 12.

Thus, an overheat-sensing temperature depends on the reference voltage VR. The overheat-sensing temperature is a temperature at which the comparator 5 outputs the overheat-sensing signal SOV and the overheat-sensing circuit 11 changes to an overheat-detected state where the transistor used in the output stage of the IC 12 is turned off.

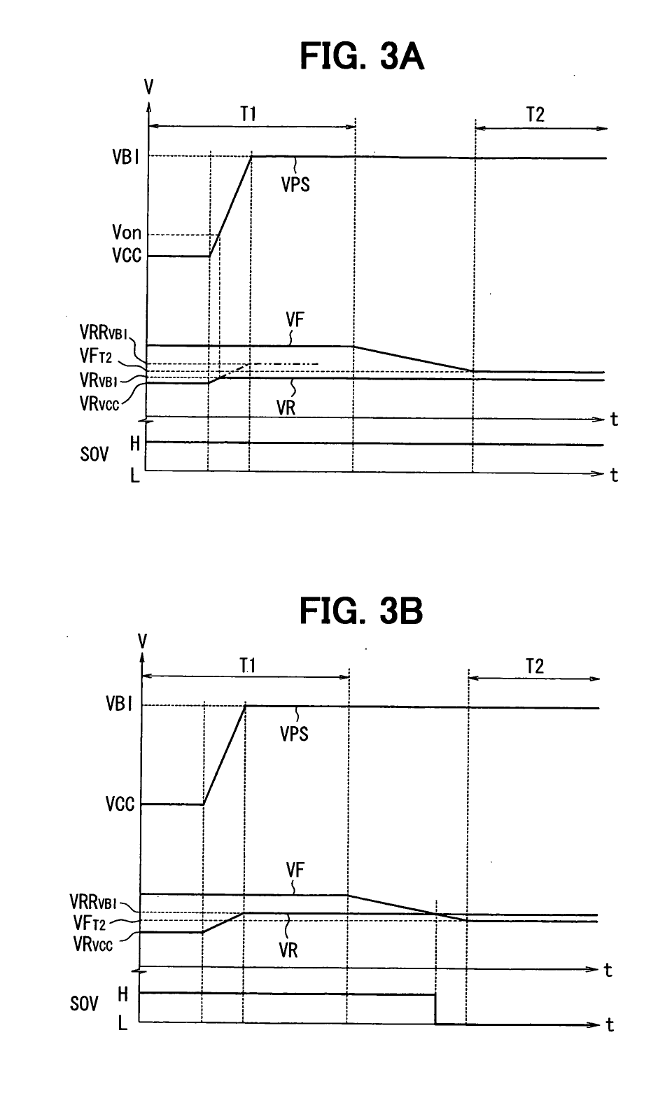

Operations of the overheat-sensing circuit 11 will now be described with further reference to FIGS. 2 to 3B.

The forward-bias voltage VF that is output from the temperature-sensing circuit 4 decreases with an increase in temperature, because the diode D1 has a negative temperature coefficient of the forward-bias voltage VF. The constant current circuit 15 provides a constant current to the diode D1 so that a dependence of the diode D1 on temperature can remain constant despite a variation in the power supply voltage VPS.

As described above, the voltage VCC, which is supplied from the external power source to the IC 12 in the normal operation, is highly accurate. In comparison with the voltage VCC, a zener voltage (i.e., breakdown voltage) VZ of the zener diode ZD1 may vary with temperature and manufacturing variations. In the normal operation, therefore, the reference voltage generation circuit 13 divides the voltage VCC by using the divider circuit 14, thereby generating an accurate reference voltage VR_{VCC}. In short, the zener diode ZD1 is held in an off state in the normal operation.

When a temperature of the diode D1, which is thermally coupled to the transistor, exceeds a first overheat-sensing temperature corresponding to the reference voltage VR_{VCC} due to overheating of the transistor, the forward-bias voltage VF of the diode D1 becomes lower than the reference voltage VR_{VCC}. Consequently, the overheat-sensing signal SOV output from the comparator 5 changes from a high level to a low level and the transistor is turned off. Thus, a thermal breakdown (i.e., short circuit) of the transistor can be prevented.

In the burn-in process, the voltage VBI higher than the voltage VCC is applied between the power terminal 12a and the ground terminal 12b of the IC 12 so that the zener diode ZD1 can be turned on. Consequently, a voltage appearing at the node N1 is limited to the zener voltage VZ. Thus, the zener diode ZD1 serves as a voltage-limiting circuit for generating a limited voltage.

When the power supply voltage VPS applied to the IC 12 increases above a voltage Von shown in FIG. 3A, the zener diode ZD1 is turned on. The voltage Von is given by the following equation;

$$Von = \frac{R 11 + R 12 + R 2}{R 12 + R 2} \cdot VZ \qquad ( 1 )$$

Because the voltage appearing at the node N1 is limited to the zener voltage VZ, a reference voltage VR_{VBI} appearing at the node N2 is given by the following equation;

$${VR}_{VBI} = \frac{R 2}{R 2 + R 12} \cdot VZ \qquad ( 2 )$$

Thus, the reference voltage VR_{VBI} is determined by the zener voltage VZ.

In the burn-in process, the temperature of the overheat-sensing circuit 11 is increased from a normal operating temperature T1 to a burn-in temperature T2. A level of the reference voltage VR_{VBI} is set below that of a forward-bias voltage VF_{T2} of the diode D1. The forward-bias voltage VF_{T2} is a voltage appearing at the node N3 at the burn-in temperature T2. In the burn-in process, therefore, the overheat-sensing signal SOV can be held at the high level until the transistor used in the output stage of the IC 12 is actually overheated.

In contrast, in the circuit shown in FIG. 5, a reference voltage VRR_{VBI} equivalent to the reference voltage VR_{VBI} is given by the following equation;

$${VRR}_{VBI} = \frac{R 2}{R 1 + R 2} \cdot VBI \qquad ( 3 )$$

Thus, the reference voltage VRR_{VBI} is determined by the voltage VBI. As shown in FIG. 3B, the reference voltage VRR_{VBI} is higher than the voltage VF_{T2} and the overheat-sensing signal SOV becomes the low level in the burn-in process. Consequently, the transistor is turned off despite the fact that the transistor is not actually overheated. Therefore, the burn-in process may not fully screen out defective products.

When the overheat-sensing circuit 11 has a normal operating voltage range, i.e., the voltage VCC, which is supplied from the external voltage source in the normal operation, varies from a minimum voltage VCCₘᵢₙ to a maximum voltage VCCₘₐₓ, the zener voltage VZ has to satisfy each of the following inequalities;

$$\begin{matrix}VZ > \frac{R 12 + R 2}{R 11 + R 12 + R 2} \cdot {VCC}_{max} & ( 4 ) \\ VZ < \frac{R 12 + R 2}{R 2} \cdot {VF}_{T 2} & ( 5 )\end{matrix}$$

The inequality (4) ensures that the zener diode ZD1 is held in the off state in the normal operation so that the reference voltage VR_{VCC} can be generated from the voltage VCC. The inequality (5) ensures that the overheat-sensing signal SOV is held at the high level in the burn-in process until the transistor is actually overheated.

By adjusting the zener voltage VZ to satisfy each of the above inequalities (4), (5), it is possible to prevent the overheat-sensing signal SOV from changing to the low level in the burn-in process until the transistor is actually overheated. In order to perform the burn-in process under a condition that is as similar as possible to that of the normal operation, the zener voltage VZ is adjusted to satisfy each of the above inequality (5) and the following equation;

$$VZ = \frac{R 12 + R 2}{R 11 + R 12 + R 2} \cdot {VCC}_{max} \qquad ( 6 )$$

When the zener voltage VZ satisfies each of the inequality (5) and the equation (6), the zener diode ZD1 is turned on at the same time the power supply voltage VPS exceeds the voltage VCCₘₐₓ. Consequently, a difference between the reference voltage VR_{VCC} in the normal operation and the reference voltage VR_{VBI} in the burn-in process is made as small as possible. In the burn-in process, therefore, the overheat-sensing circuit 11 change to the overheat detected state at a second overheat-sensing temperature that is very close to the first overheat-sensing temperature in the normal operation. Thus, the burn-in process can be performed under the condition as similar as possible to that of the normal operation.

Because there is a relatively large variation in the zener voltage VZ, it is preferable that the zener diode ZD1 can be turned on at the same time the power supply voltage VPS exceeds a predetermined voltage that is the sum of the voltage VCCₘₐₓ and some voltage margin. Therefore, if the zener voltage VZ varies from a minimum zener voltage VZₘᵢₙ to a maximum zener voltage VZₘₐₓ, it is preferable that the zener voltage VZ can satisfy the following equation;

$${VZ}_{min} = \frac{R 12 + R 2}{R 11 + R 12 + R 2} \cdot {VCC}_{max} \qquad ( 7 )$$

As described above, the reference voltage generation circuit 13 includes the voltage divider circuit 14 and the zener diode ZD1.

In the normal operation, the voltage VCC, which is highly accurate and varies from the voltage VCCₘᵢₙ to the voltage VCCₘₐₓ, is applied to the IC 12 so that the zener diode ZD1 can be held in the off state. The voltage divider circuit 14 outputs the reference voltage VR_{VCC} that depends on the voltage VCC and is highly accurate.

By using the reference voltage VR_{VCC}, the overheat-sensing circuit 11 can highly accurately detect the overheating of the transistor used in the output stage of the IC 12.

In the burn-in process, the voltage VBI higher than the voltage VCC is applied to the IC 12 so that the zener diode ZD1 can be turned on. The voltage divider circuit 14 outputs the reference voltage VR_{VBI} that depends on the zener voltage VZ. Thus, the zener diode ZD1 limits the increase in the reference voltage VR when the power supply voltage VPS increases from the voltage VCC to the voltage VBI. In other words, the zener diode ZD1 limits the decrease in the overheat-sensing temperature when the power supply voltage VPS increases from the voltage VCC to the voltage VBI. In such an approach, the overheat-sensing signal SOV can be held at a high level in the burn-in process until the transistor is actually overheated. Therefore, the burn-in process can screen out the defective products.

The resistors R11, R12, and R2 may be adjusted to satisfy the equation (7) in consideration of the variation in the zener voltage VZ. The equation (7) ensures that the zener diode ZD1 can be turned on at the time the power supply voltage VPS increases to the voltage VCCₘₐₓ, even if the zener voltage VZ has the minimum voltage VZₘᵢₙ. Thus, it is ensured that the reference voltage VR_{VCC} is generated in the normal operation and the reference voltage VR_{VBI} is generated in the burn-in process. Further, because the difference between the reference voltage VR_{VCC} and the reference voltage VR_{VBI} is made as small as possible, the burn-in process can be performed under the condition similar to that of the normal operation.

(Second Embodiment)

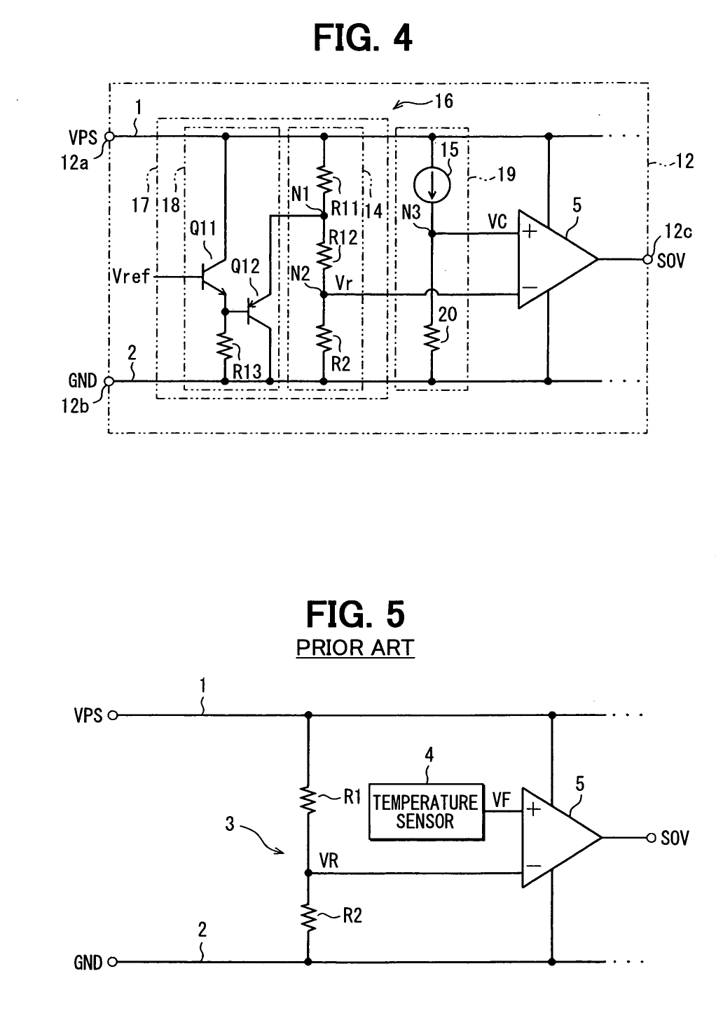

An overheat-sensing circuit 16 according to a second embodiment of the present invention will now be described with reference to FIG. 4.

The overheat-sensing circuit 16 includes a temperature-sensing circuit 19, the comparator 5, and a reference voltage generation circuit 17.

The temperature-sensing circuit 19 has the constant current circuit 15 and a negative temperature coefficient (NTC) thermistor 20 that are connected in series between the power line 1 and the ground line 2. The constant current circuit 15 is connected to the NTC thermistor 20 at a node N3 and the temperature-sensing circuit 19 outputs a temperature-sensing voltage VC that appears at the node N3. Because a resistance of the NTC thermistor 20 decreases with an increase in temperature, the temperature-sensing voltage VC also decreases with the increase in temperature.

The reference voltage generation circuit 17 includes the voltage divider circuit 14 and a clamp circuit 18. The clamp circuit 18 has transistors Q11, Q12 and a resistor R13. The transistor Q11 has a collector connected to the power line 1, an emitter connected to the ground line 2 through the resistor R13, and a base to which a predetermined voltage Vref is applied. The voltage Vref is generated in a simple way inside the IC 12 and has a relatively poor accuracy. The transistor Q12 has a collector connected to the ground line 2, an emitter connected to the node N1 of the voltage divider circuit 14, and a base connected to the emitter of the transistor Q11. The voltage Vref appears at the node N1 when the transistor Q12 is turned on.

When the voltage appearing at the node N1 decreases below the voltage Vref, the clamp circuit 18 is turned off. In contrast, when the voltage appearing at the node N1 increases to the voltage Vref, the clamp circuit 18 is turned on so that the voltage appearing at the node N1 is clamped to the predetermined voltage Vref. Thus, the clamp circuit 18 serves as the voltage-limiting circuit for generating the limited voltage.

As described above, the temperature-sensing voltage VC output from the temperature-sensing circuit 19 decreases with the increase in temperature. Therefore, the voltage Vref and the temperature-sensing voltage VC of the second embodiment correspond to the forward-bias voltage VF and the zener voltage VZ of the first embodiment, respectively, so that the equations and inequalities (1) to (7) of the first embodiment can be applied to the second embodiment.

(Modifications)

The embodiments described above may be modified in various ways. For example, various types of circuits that can output voltage linearly or nonlinearly with temperature may be used as the temperature-sensing circuits 4, 19.

Various types of clamp circuits instead of the zener diode ZD1 or the clamp circuit 18 may be used as the voltage-limiting circuit.

The predermined voltage Vref of the second embodiment may be supplied from outside the IC 12.

Such changes and modifications are to be understood as being within the scope of the present invention as defined by the appended claims.

What is claimed is:

1. An overheat-sensing circuit having a normal operating voltage range and supplied with a power supply voltage from an external voltage source, the overheat-sensing circuit comprising:
a temperature-sensing circuit for outputting a temperature-sensing voltage that depends on temperature;
a reference voltage generation circuit for outputting a reference voltage; and
a comparison circuit that compares the temperature-sensing voltage with the reference voltage and outputs an overheat-sensing signal based on a result of the comparison, wherein
the reference voltage generation circuit outputs the reference voltage in accordance with the power supply voltage when the power supply voltage is within a predetermined voltage range, and generates a limited voltage based on the power supply voltage and outputs the reference voltage in accordance with the limited voltage when the power supply voltage is outside the predetermined voltage range.

2. The overheat-sensing circuit according to claim 1, wherein
the predetermined voltage range is approximately equal to the normal operating voltage range.

3. The overheat-sensing circuit according to claim 1, wherein
the predetermined voltage range is a sum of the normal operating voltage range and a predetermined voltage margin.

4. The overheat-sensing circuit according to claim 1, wherein
the reference voltage generation circuit includes a voltage divider circuit that divides the power supply voltage by a predetermined voltage division ratio to generate the reference voltage and a voltage-limiting circuit that provides the limited voltage to the voltage divider circuit when the power supply voltage is outside the predetermined voltage range.

5. The overheat-sensing circuit according to claim 4, wherein
the limited voltage changes the voltage division ratio of the voltage divider circuit.

6. The overheat-sensing circuit according to claim 4, wherein
the voltage-limiting circuit is a zener diode.

7. The overheat-sensing circuit according to claim 4, wherein
the voltage-limiting circuit is a clamp circuit.

8. A semiconductor device having the overheat-sensing circuit of claim 1, wherein
the semiconductor device is supplied with the power supply voltage that is outside the normal operating voltage range in a screening process.
